(19) United States
(12) Patent Application Publication
(10) Pub. No.: US 2018/0375410 A1
(43) Pub. Date: Dec. 27, 2018

(54) INTEGRATED STATOR MODULE FOR AN ELECTRIC MOTOR

(71) Applicant: BorgWarner Inc., Auburn Hills, MI (US)

(72) Inventors: Tobias MOSER, lmmenstaad (DE); Frank Michael HAASE, Markdorf (DE)

(21) Appl. No.: 16/015,396

(22) Filed: Jun. 22, 2018

(30) Foreign Application Priority Data
Jun. 23, 2017 (DE) 102017210624.7

(51) Int. Cl. H02K 15/10; H02K 1/14; H02K 3/18; H02K 3/52; H02K 5/173; H02K 15/02; H02K 3/32; F04D 25/06

(52) U.S. Cl. CPC H02K 15/105; H02K 1/14; H02K 3/18; F04D 25/0646; H02K 5/173; H02K 15/022; H02K 3/325; H02K 3/521

(57) ABSTRACT

The invention relates to a method for producing a stator module (10) for an electric motor. The method comprises the following steps: provision of a core (100) comprising a centrally-arranged bearing seat (130), an annular yoke (110), and a plurality of teeth (120) which extend radially outward from the annular yoke (110); arrangement of a bearing (200) in the bearing seat (130); arrangement of a connector assembly (300) on a radial side surface of the yoke (110); and overmolding the core (100) and the connector assembly (300) with an insulating material (400) so that the connector assembly (300) is fixed on the core (100), wherein the insulating material (400) defines an axial position of the bearing (200) in the bearing seat (130) after the overmolding.

### CROSS-REFERENCE TO RELATED APPLICATIONS

This application claims the benefit of German Patent Application No. 102017210624.7 filed Jun. 23, 2017, the disclosure of which is herein incorporated by reference in its entirety.

### FIELD OF THE INVENTION

The present invention relates to a stator module for an electric motor and a method for producing a stator module for an electric motor.

### BACKGROUND INFORMATION

In order to regulate the temperature balance of modern motor vehicles, fans are used for cooling the internal combustion engine or other components of the drivetrain. Fans of this type are known, for example, from DE 10 2010 039 219 A1.

The fans may be driven, for example, via an electric motor which must satisfy specific demands in durability and wear resistance, as it is exposed to vibrations, dirt, and moisture. The electric motor may, for example, be an external rotor motor which is integrated in the area of the hub of the fan wheel of the fan. These types of electric motors have a stator and a rotor. Stator modules for known electric motors are sometimes expensive to produce, have poor insulation, and/or are insufficiently protected from dirt and moisture.

The object of the present invention is to provide a method that enables a more efficient production of a stator module with insulation for an electric motor. Another object of the present invention is to provide a more efficiently producible stator module with insulation.

### BRIEF SUMMARY OF THE INVENTION

The present invention relates to a method for producing a stator module according to Claim 1, a stator module according to Claim 9 and according to Claim 10, and an electric motor according to Claim 15.

The method according to the invention for producing a stator module for an electric motor comprises the following steps: provision of a core with a centrally-arranged bearing seat, an annular yoke, and a plurality of teeth which extend radially outward from the annular yoke; arrangement of a bearing in the bearing seat; arrangement of a connector assembly on a radial side surface of the yoke; and overmolding the core and the connector assembly with an insulating material so that the connector assembly is fixed on the core, wherein the insulating material determines an axial position of the bearing after the overmolding. By using the method according to the invention for producing a stator module, multiple assembly steps may be omitted in comparison to known production methods, and thus potential errors during assembly may thus also be prevented. In addition, additional structural features, for example, guides for the windings, may be directly injection molded on the core of the stator module during the overmolding, and thus be integrated into one component.

In embodiments of the method, the connector assembly may have at least two busbars with respectively one phase contact and a plurality of winding contacts, wherein the phase contacts and the winding contacts project out of the insulating material in the axial direction after the overmolding. The busbars may be arranged on the yoke in a preformed holder for the connector assembly.

The method may additionally comprise winding the teeth so that the resulting windings are in contact with the corresponding winding contacts.

In embodiments of the method which are combinable with all previously described embodiments, the step of arranging the bearing in the bearing seat may comprise pressing the bearing in the bearing seat.

In embodiments of the method which are combinable with all previously described embodiments, the teeth may be completely enveloped by the insulating material after the overmolding up to a side surface extending axially and facing radially outward.

In embodiments of the method which are combinable with all previously described embodiments, grooves may be injected into the insulating material in the area of the radial side surfaces of the teeth.

In embodiments of the method which are combinable with all previously described embodiments, guides may be extruded in the area of an outer edge of the connector assembly and along the periphery of the annular yoke during the overmolding.

In embodiments of the method which are combinable with all previously described embodiments, at least two bars, which connect the yoke with the bearing seat, may extend radially outward from the bearing seat to the annular yoke, wherein at least one through passage completely penetrating the respective bar may be provided in each bar, wherein the through passages may be completely lined or filled with insulating material during the overmolding. By this means, the insulating material is better fixed to the core. Each of the bars may have a fixing receptacle, wherein the fixing receptacle is not lined with insulating material during the overmolding.

The invention additionally comprises a stator module for an electric motor comprising a core with a centrally-arranged bearing seat in which a bearing is arranged, an annular yoke, and a plurality of teeth, which extend radially outward from the yoke. The stator module additionally comprises a connector assembly which is arranged on a radial side surface of the yoke, wherein the core and the connector assembly are substantially encapsulated in an insulating material. The stator module is produced in a method according to any one of the preceding embodiments.

The invention additionally comprises a stator module for an electric motor comprising a core with a centrally-arranged bearing seat in which a bearing is arranged, an annular yoke, and a plurality of teeth, which extend radially outward from the yoke. The stator module additionally comprises a connector assembly which is arranged on a radial side surface of the yoke. The core and the connector assembly are substantially encapsulated in an insulating material so that the connector assembly is fixed on the core by the insulating material and the insulating material defines an axial position of the bearing in the bearing seat. The overmolding made from the insulating material functions on the one hand for electrical insulation, and additionally protects the entire stator module, including the connector assembly and the bearing seat, from dirt and water.

In embodiments of the previously described stator module, the connector assembly may have at least two busbars with one phase contact and a plurality of winding contacts respectively, wherein the phase contacts and the winding contacts project out of the insulating material in the axial direction. The phase contacts and the winding contacts extend in the axial direction from an annular base of the busbars. Free ends of the winding contacts may, for example, be configured as forked.

In embodiments of the stator module which are combinable with all previously described embodiments, the teeth may be completely enveloped by the insulating material after the overmolding up to a side surface extending axially and facing radially outward.

In embodiments of the stator module, which are combinable with all previously described embodiments, the insulating material may have grooves in the area of the radial side surfaces of the teeth. The grooves function for easier arrangement and positioning of the windings around the teeth.

In embodiments of the stator module, which are combinable with all previously described embodiments, guides may be provided in the area of an outer edge of the connector assembly and along the periphery of the annular yoke. The number of guides may correspond to the number of teeth, and the guides may be uniformly spaced along the periphery and may be arranged centered in each case with respect to one tooth.

In embodiments of the stator module, which are combinable with all previously described embodiments, at least two bars, which connect the yoke to the bearing seat, may extend radially outward from the bearing seat to the annular yoke. At least one through passage completely penetrating the respective bar may be provided in each bar, wherein the through passages may be completely lined or filled with insulating material. By this means, the insulating material is better fixed to the core. Each of the bars may have a fixing receptacle, wherein the fixing receptacle is not lined with insulating material during the overmolding.

The invention additionally comprises an electric motor, in particular an electric motor for a fan, with a rotor and a stator module according to any one of the previously described embodiments. In embodiments, the electric motor may be an external rotor motor.

Additional details and features of the invention are subsequently described by way of the figures.

### BRIEF DESCRIPTION OF THE DRAWINGS

FIG. 1 shows a cutaway view of a first embodiment of the stator module according to the invention without insulating material;

FIG. 2 shows a cutaway view of the embodiment of the stator module according to the invention from FIG. 1 with insulating material;

FIG. 3 shows an enlarged partial view of a second embodiment of the stator module according to the invention.

### DETAILED DESCRIPTION OF THE INVENTION

In the following, embodiments for stator module 10 according to the invention and also a method for producing stator module 10 according to the invention will be described by way of the figures. Within the context of this application, the term “axial” refers to directions/orientations that extend substantially parallel to center axis/axis of rotation 500. The term “radial” refers to directions/orientations that extend substantially perpendicular to center axis/axis of rotation 500. Radial surfaces are correspondingly surfaces which lie in planes that extend perpendicular to center axis/axis of rotation 500.

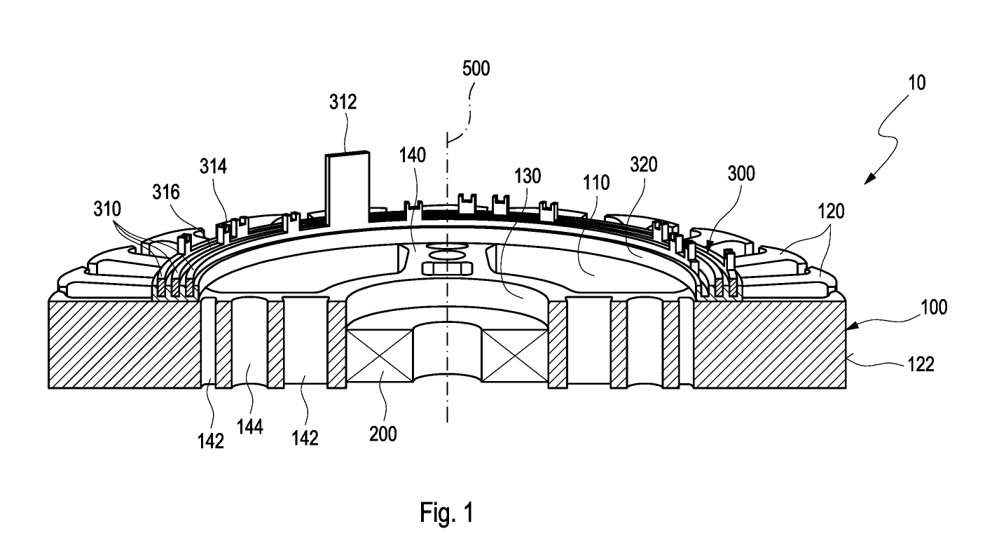

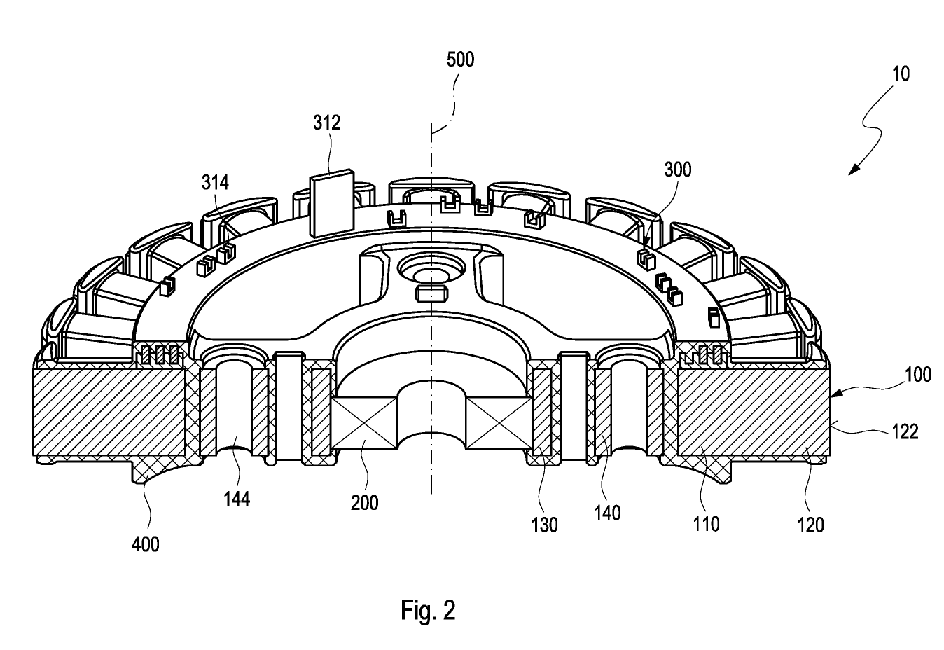

In the following, embodiments of stator module 10 according to the invention will be initially described by way of FIGS. 1 through 3. Subsequently, the method according to the invention for producing stator module 10 will be described by way of FIG. 1 and FIG. 2.

With reference to FIG. 1 and FIG. 2, stator module 10 for an electric motor comprises a core 100 with a centrally-arranged bearing seat 130, an annular yoke 110, and a plurality of teeth 120 which extend radially outward from yoke 110. A bearing 200 is arranged in bearing seat 130. Core 100 may be constructed, for example, from folded electrical steel sheets. The electrical steel sheets may be, for example, fused together or “punched-stacked”. Bearing 200 may be, for example, an angular ball bearing. In particular, a double row angular ball bearing may be provided. Stator module 10 additionally comprises a connector assembly 300, which is arranged on a radial side surface of yoke 110. Core 100 and connector assembly 300 may be substantially encapsulated in an insulating material 400. FIG. 1 shows core 100 and connector assembly 300 without insulating material 400, whereas FIG. 2 shows stator module 10 including insulating material 400. Insulating material 400 is applied in such a way that connector assembly 300 is fixed on core 100 by insulating material 400, and insulating material 400 determines an axial position of bearing 200 in bearing seat 130. The overmolding made from insulating material 400 functions on the one hand for electrical insulation, and on the other hand protects the entire stator module 10, including connector assembly 300 and bearing seat 130, from dirt and water. Insulating material 400 may be, for example, a thermoplastic injection molding material. The insulating material may be, in particular, a polyamide, preferably polyamide 6. For example, PA6-GF30 may be used, a polyamide 6 reinforced with 30 wt. % glass fibers. Alternatively, the insulating material may also be a duroplastic. Center axis 500 of stator module 10 indicated in FIG. 1 and FIG. 2 is simultaneously the axis of rotation of a rotor of an electric external rotor motor, which may be arranged around stator module 10. A rotor of this type may be rotatably mounted, for example, in bearing 200.

As is clear in FIG. 1, connector assembly 300 has three busbars 310, each comprising a phase contact 312 and a plurality of winding contacts 314. However, connector assembly 300 may also have only two busbars 310 or also more than three busbars 310. Busbars 310 are arranged on yoke 110 in a preformed holder 320 of connector assembly 300 (see FIG. 1). Holder 320 is likewise configured as annular in correspondence with the annular yoke, and has on its upper side annular accommodation slots, likewise arranged concentrically to center axis 500 and corresponding to the number of busbars 310 provided. Busbars 310 are arranged in the accommodation slots.

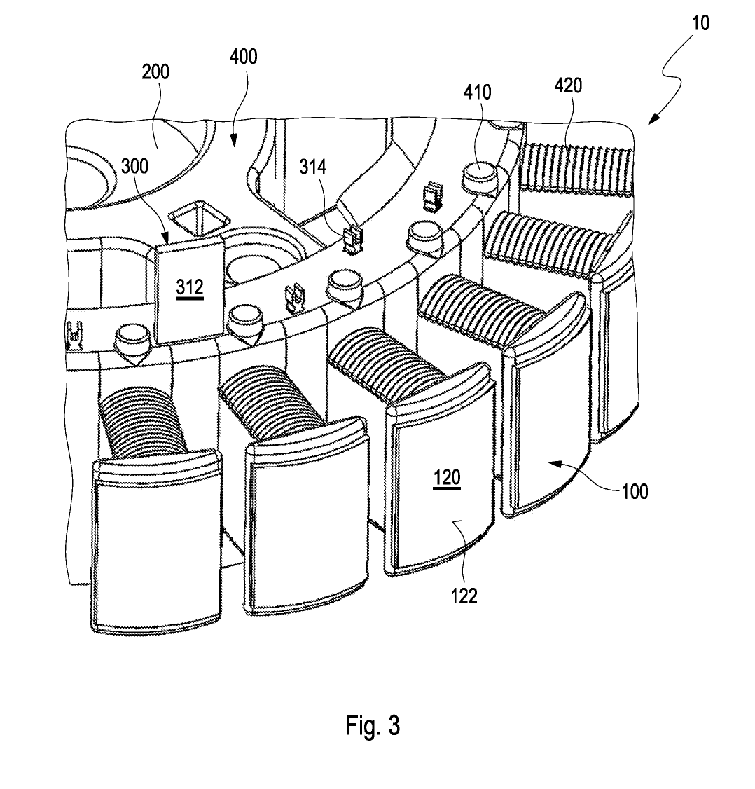

Phase contacts 312 and winding contacts 314 extend in the axial direction from an annular base 316 of busbars 310 (see FIG. 1). Due to this, phase contacts 312 and winding contacts 314 project in the axial direction out of insulating material 400 (see FIG. 2). Phase contacts 312 function for connecting stator module 10 or connector assembly 300 to a power supply and control unit of the electric motor. Winding contacts 314 function for contacting with the windings (not shown) of the stator in order to supply these with current. The windings may, for example, be welded to winding contacts 314. Free ends of winding contacts 314 may, for example, be configured as forked (see also FIG. 3).

Teeth 120 of core 100 are completely enveloped by insulating material 400 up to a side surface 122 facing radially outward.

Four bars 140 (of which one is shown in its entirety and two are shown in cross section in FIG. 1 and FIG. 2) extend radially outward from centrally-arranged bearing seat 130 to annular yoke 110. However, only two bars, three bars, or more than four bars may also be provided. Bars 140 connect yoke 110 to bearing seat 130. As is very clear in FIG. 1 and FIG. 2, two through passages 142, completely penetrating through the respective bar 140, are provided in each bar 140. Alternatively, only one through passage 142 or more than two through passages 142 may be provided per bar 140. However, a through passage 142 does not have to be arranged in every bar 140, for example, one or more through passages 142 may be arranged only in every second bar 140. Through passages 142 are either completely lined with insulating material 400 (like radially inner through passages 142 in the examples shown in FIG. 1 and FIG. 2) or are completely filled with insulating material (like radially outer through passages 142 in the examples shown in FIG. 1 and FIG. 2). Due to this type of through passages 142, the layer made from insulating material 400 is better fixed on core 100. Each of bars 140 additionally has a fixing receptacle 144, wherein walls of fixing receptacles 144 are not lined with insulating material 400 (see FIG. 2). Fixing receptacles 144 may function, for example, to connect stator module 10 to other components of an electric motor or for fixing an electric motor in which a stator module 10 according to the invention is provided. However, each bar 140 does not have to have a fixing receptacle 144. For example, only every second bar 140 may have a fixing receptacle 144, corresponding or alternating with through passages 142.

With respect to FIG. 3, another embodiment of stator module 10 according to the invention is described. In comparison to the stator module from FIG. 2, stator module 10 from FIG. 3 has additional grooves 420 in insulating material 400 in the area of the radial side surfaces of teeth 120. Grooves 420 function for easier arrangement and positioning of the windings around teeth 120.

Likewise in FIG. 3, optional guides 410 are shown, which may be provided in the area of an outer edge of connector assembly 300 and along the periphery of annular yoke 110. As is clear in FIG. 3, guides 410 may be configured, for example, as axially extending cylindrical or slightly conical projections, and function as guides for the windings (not shown). The number of guides 410 may correspond to the number of teeth 120, and guides 410 may be uniformly spaced along the periphery and may be arranged centered in each case with respect to one tooth 120 (see FIG. 3).

Although both guides 410 and also grooves 420 are shown in the embodiment from FIG. 3, only grooves 410 or only guides 410 may also be provided.

The invention additionally comprises a method for producing a stator module 10 for an electric motor. The steps of the method according to the invention are described in the following. Initially, core 100 is provided, comprising centrally-arranged bearing seat 130, annular yoke 110, and the plurality of teeth 120, which extend radially outward from annular yoke 110. Bearing 200 is then arranged in the bearing seat. Bearing 200 may, for example, be pressed into bearing seat 130. Connector assembly 300 is arranged on a radial side surface of yoke 110. Core 100 is depicted in FIG. 1 with bearing 200 arranged in bearing seat 130 of core 100 and connector assembly 300 arranged on yoke 110 of core 130. Then, the overmolding of core 100 and connector assembly 300 is carried out using insulating material 400, so that connector assembly 300 is fixed on core 100 and insulating material 400 determines an axial position of bearing 200 in bearing seat 130 after the overmolding. The finished, overmolded stator module 10 is depicted in FIG. 2. The overmolding may, for example, be carried out in an injection molding system provided for this, wherein core 100, with bearing 200 and connector assembly 300 placed on core 100, is positioned in a mold of the injection molding system and then overmolded with insulating material 400. Due to the method according to the invention for producing a stator module 10, several assembly steps may be omitted in comparison to known production methods, and thus also potential errors may be prevented during the assembly, as core 100, bearing 200, and connector assembly 300 are overmolded with insulating material 400 in one processing step, and connector assembly 300 is thereby simultaneously fixed on core 100 and the axial position of bearing 200 is defined in bearing seat 130. In addition, additional structural features, for example, guides 410 described above or grooves 420 in the area of teeth 120, may be directly injection molded on core 100 of stator module 10 during the overmolding, and thus be integrated into one component.

The overmolding is thereby carried out in such a way that phase contacts 312 and winding contacts 314 project out of insulating material 400 in the axial direction after the overmolding (see FIG. 2) such that stator module 10 or connector assembly 300 may be connected via phase contacts 312 to a power supply and control unit of the electric motor, and winding contacts 314 may contact the windings of the stator in order to supply the same with current. The windings may, for example, be welded to winding contacts 314. For a simple assembly, busbars 310 are arranged on yoke 110 in preformed holder 320 of connector assembly 300 (see FIG. 1). As already mentioned above, holder 320 is likewise configured as annular in correspondence with the annular yoke, and has on its upper side annular accommodation slots likewise arranged concentrically to center axis 500 and corresponding to the number of busbars 310 provided. Busbars 310 are previously arranged in the accommodation slots. Holder 320 may be produced, for example, in the injection molding method and may likewise comprise an insulating material.

The method may additionally comprise winding teeth 120 so that the resulting windings are in contact with corresponding winding contacts 314.

It should be taken into consideration during the overmolding that teeth 120 are each completely enveloped by insulating material 400 up to a side surface 122 extending axially and facing radially outward. Optionally, grooves 420 may be injected molded into insulating material 400 in the area of the radial side surfaces of teeth 120. Alternatively or additionally, guides 410 may be extruded in the area of an outer edge of connector assembly 300 and along the periphery of annular yoke 110 during the overmolding.

It should additionally be taken into consideration during the overmolding, that through passages 142 are completely lined or filled with insulating material 400 (compare FIG. 1 with FIG. 2). By this means, the insulating material is better fixed to the core. Fixing receptacles 144 should not be lined with insulating material 400 during the overmolding.

The invention additionally comprises an electric motor with a rotor and a stator module 10 according to any one of the previously described embodiments. In embodiments, the electric motor may be an external rotor motor. The electric motor may be, for example, a brushless DC motor. The electric motor may be adapted, for example, in order to be used in an electrically driven fan. The invention thus also comprises an electrically driven fan with an electric motor with a previously described stator module. Although the present invention has been described above and is defined in the attached claims, it should be understood that the invention may also be alternatively defined according to the following embodiments:
1. A method for producing a stator module (10) for an electric motor comprising the following steps:
   providing a core (100) comprising a centrally-arranged bearing seat (130), an annular yoke (110), and a plurality of teeth (120) which extend radially outward from the annular yoke (110);
   arrangement of a bearing (200) in the bearing seat (130);
   arrangement of a connector assembly (300) on a radial side surface of the yoke (110); and
   overmolding of the core (100) and the connector assembly (300) with insulating material (400), so that the connector assembly (300) is fixed on the core (100), wherein the insulating material (400) defines an axial position of the bearing (200) in the bearing seat (130) after the overmolding.
2. The method according to Embodiment 1, characterized in that the connector assembly (300) has at least two busbars (310) with respectively one phase contact (312) and a plurality of winding contacts (314), wherein the phase contacts (312) and the winding contacts (314) project out of the insulating material (400) in the axial direction after the overmolding.
3. The method according to Embodiment 2, characterized in that the busbars (310) are arranged on the yoke (110) in a preformed holder (320) of the connector assembly (300).
4. The method according to Embodiment 2 or Embodiment 3, additionally comprising winding the teeth (120) so that the resulting windings are in contact with the corresponding winding contacts (314).
5. The method according to any one of the preceding embodiments, characterized in that the step of arranging the bearing (200) in the bearing seat (130) comprises pressing the bearing (200) into the bearing seat (130).
6. The method according to any one of the preceding embodiments, characterized in that the teeth (120) are each completely enveloped by the insulating material (400) after the overmolding up to a side surface (122) extending axially and facing radially outward.
7. The method according to any one of the preceding embodiments, characterized in that grooves (420) are injection molded into the insulating material (400) in the area of the radial side surfaces of the teeth (120).
8. The method according to any one of the preceding embodiments, characterized in that guides (410) are extruded during the overmolding in the area of an outer edge of the connector assembly (300) and along the periphery of the annular yoke (110).
9. The method according to any one of the preceding embodiments, characterized in that at least two bars (140), which connect the yoke (110) to the bearing seat (130), extend radially outwardly from the bearing seat (130) to the annular yoke (110), wherein at least one through passage (142), completely penetrating the respective bar (140), is provided in each bar (140), wherein the through passages (142) are completely lined or filled by the insulating material (400) during the overmolding.
10. The method according to Embodiment 9, characterized in that each of the bars (140) has a fixing receptacle (144), wherein the fixing receptacle (144) is not lined with insulating material (400) during the overmolding.
11. A stator module for an electric motor comprising a core (100) comprising a bearing (200) arranged in a centrally-arranged bearing seat (130), an annular yoke (110), and a plurality of teeth (120) which extend radially outward from the annular yoke (110); and
   a connector assembly (300) which is arranged on a radial side surface of the yoke (110);
   wherein the core (100) and the connector assembly (300) are substantially encapsulated in an insulating material (400), characterized in that the stator module (10) is produced in a method according to any one of the preceding embodiments.
12. A stator module for an electric motor comprising a core (100) comprising a bearing (200) arranged in a centrally-arranged bearing seat (130), an annular yoke (110), and a plurality of teeth (120) which extend radially outward from the annular yoke (110); and a connector assembly (300) which is arranged on a radial side surface of the yoke (110);
   characterized in that the core (100) and the connector assembly (300) are substantially encapsulated in an insulating material (400) so that the connector assembly (300) is fixed on the core (100) by the insulating material (400) and the insulating material (400) defines an axial position of the bearing (200) in the bearing seat (130).
13. The stator module according to Embodiment 11 or Embodiment 12, characterized in that the connector assembly (300) has at least two busbars (310) with respectively one phase contact (312) and a plurality of winding contacts (314), wherein the phase contacts (312) and the winding contacts (314) project out of the insulating material (400) in the axial direction after the overmolding.
14. The stator module according to Embodiment 13, characterized in that the phase contacts (312) and the winding contacts (314) extend in the axial direction from an annular base (316) of the busbars (310).
15. The stator module according to Embodiment 13 or Embodiment 14, characterized in that free ends of the winding contacts (314) are configured as forked.
16. The stator module according to any one of Embodiments 11 through 15, characterized in that the teeth (120) are completely enveloped by the insulating material (400) up to a side surface (122) facing radially outward.
17. The stator module according to any one of Embodiments 11 through 16, characterized in that the insulating material has grooves (420) in the area of the radial side surfaces of the teeth (120).
18. The stator module according to any one of Embodiments 11 through 17, characterized in that guides (410) are provided in the area of an outer edge of the connector assembly (300) and along the periphery of the annular yoke (110).
19. The stator module according to Embodiment 18, characterized in that the number of guides (410) corresponds to the number of teeth (120) and the guides (410) are spaced uniformly across the periphery and are arranged centered in each case with respect to one tooth (120).
20. The stator module according to any one of Embodiments 11 through 19, characterized in that at least two bars (140), which connect the yoke (110) to the bearing seat (130), extend radially outwardly from the bearing seat (130) to the annular yoke (110), wherein at least one through passage (142), completely penetrating the respective bar (140), is provided in each bar (140), wherein the through passages (142) are completely lined or filled by the insulating material (400).
21. The stator module according to Embodiment 20, characterized in that each of the bars (140) has a fixing receptacle (144), wherein the walls of the fixing receptacle (144) are not lined with insulating material (400).
22. An electric motor, in particular an electric motor for a fan, comprising a rotor and a stator module (10) according to any one of Embodiments 11 through 21.
23. The electric motor according to Embodiment 22, characterized in that the electric motor is an external rotor motor.
24. An electrically driven fan with an electric motor according to Embodiment 22 or Embodiment 23.

1. A method for producing a stator module (10) for an electric motor comprising the following steps:
providing a core (100) comprising a centrally-arranged bearing seat (130), an annular yoke (110), and a plurality of teeth (120) which extend radially outward from the annular yoke (110);
arrangement of a bearing (200) in the bearing seat (130);
arrangement of a connector assembly (300) on a radial side surface of the yoke (110); and
overmolding of the core (100) and the connector assembly (300) with insulating material (400), so that the connector assembly (300) is fixed on the core (100), wherein the insulating material (400) defines an axial position of the bearing (200) in the bearing seat (130) after the overmolding.

2. The method according to claim 1, characterized in that the connector assembly (300) has at least two busbars (310) with respectively one phase contact (312) and a plurality of winding contacts (314), wherein the phase contacts (312) and the winding contacts (314) project out of the insulating material (400) in the axial direction after the overmolding.

3. The method according to claim 2, characterized in that the busbars (310) are arranged on the yoke (110) in a preformed holder (320) of the connector assembly (300).

4. The method according to claim 1, characterized in that the teeth (120) are each completely enveloped by the insulating material (400) after the overmolding up to a side surface (122) extending axially and facing radially outward.

5. The method according to claim 1, characterized in that grooves (420) are injection molded into the insulating material (400) in the area of the radial side surfaces of the teeth (120).

6. The method according to claim 1, characterized in that guides (410) are extruded during the overmolding in the area of an outer edge of the connector assembly (300) and along the periphery of the annular yoke (110).

7. The method according to claim 1, characterized in that at least two bars (140), which connect the yoke (110) to the bearing seat (130), extend radially outwardly from the bearing seat (130) to the annular yoke (110), wherein at least one through passage (142), completely penetrating the respective bar (140), is provided in each bar (140), wherein the through passages (142) are completely lined or filled by the insulating material (400) during the overmolding.

8. The method according to claim 7, characterized in that each of the bars (140) has a fixing receptacle (144), wherein the fixing receptacle (144) is not lined with insulating material (400) during the overmolding.

9. A stator module for an electric motor comprising
a core (100) comprising a bearing (200) arranged in a centrally-arranged bearing seat (130), an annular yoke (110), and a plurality of teeth (120) which extend radially outward from the annular yoke (110);
a connector assembly (300) which is arranged on a radial side surface of the yoke (110);
wherein the core (100) and the connector assembly (300) are substantially encapsulated in an insulating material (400), characterized in that the stator module (10) is produced in a method according to claim 1.

10. A stator module for an electric motor comprising a core (100) comprising a bearing (200) arranged in a centrally-arranged bearing seat (130), an annular yoke (110), and a plurality of teeth (120) which extend radially outward from the annular yoke (110); and
a connector assembly (300) which is arranged on a radial side surface of the yoke (110);
characterized in that the core (100) and the connector assembly (300) are substantially encapsulated in an insulating material (400) so that the connector assembly (300) is fixed on the core (100) by the insulating material (400) and the insulating material (400) defines an axial position of the bearing (200) in the bearing seat (130).

11. The stator module according to claim 10, characterized in that the connector assembly (300) has at least two busbars (310) with respectively one phase contact (312) and a plurality of winding contacts (314), wherein the phase contacts (312) and the winding contacts (314) project out of the insulating material (400) in the axial direction after the overmolding.

12. The stator module according to claim 11, characterized in that free ends of the winding contacts (314) are configured as forked.

13. The stator module according to claim 10, characterized in that guides (410) are provided in the area of an outer edge of the connector assembly (300) and along the periphery of the annular yoke (110); in particular wherein the number of guides (410) corresponds to the number of teeth (120) and the guides (410) are uniformly spaced across the periphery and are arranged in each case centered with respect to one tooth (120).

14. The stator module according to claim 10, characterized in that at least two bars (140), which connect the yoke (110) to the bearing seat (130), extend radially outwardly from the bearing seat (130) to the annular yoke (110), wherein each of the bars (140) has a fixing receptacle (144), wherein the walls of the fixing receptacle (144) are not lined with insulating material (400).

15. An electric motor, in particular an electric external rotor motor for a fan, comprising a rotor and a stator module (10) according to claim 10.
